(19) United States
(12) Patent Application Publication
(10) Pub. No.: US 2021/0127603 A1
(43) Pub. Date: May 6, 2021

(54) INTEGRATED INTELLIGENT IRRIGATION SYSTEM DESIGN, IMPLEMENTATION AND MONITORING

(71) Applicant: JAIN AGRICULTURE SERVICES AUSTRALIA PTY LTD, Fitzroy, Victoria (AU)

(72) Inventor: James Matthew PRYOR, Fitzroy (AU)

(73) Assignee: JAIN AGRICULTURE SERVICES AUSTRALIA PTY LTD, Fitzroy, Victoria (AU)

(21) Appl. No.: 16/772,513

(22) PCT Filed: Sep. 12, 2018
(86) PCT No.: PCT/AU2018/050990

§ 371 Date: Jun. 12, 2020

(30) Foreign Application Priority Data
Sep. 12, 2017 (AU) 2017903691

(51) Int. Cl. A01G 25/16; G06N 20/00; G06Q 50/02; G05B 13/04; G05B 19/46

(52) U.S. Cl. CPC A01G 25/16; G06N 20/00; G05B 2219/2625; G05B 13/04; G05B 19/46; G06Q 50/02

(57) ABSTRACT

A method for optimally designing an irrigation system and managing/operating the designed irrigation system in real time comprising: •receiving data associated with a proposed irrigation design; •analysing the proposed design comprising one or more proposed measurements and automation requirements; •retrieving one or more pre-established estimation rules from a data store and mapping them with the proposed design; •estimating additional measurement and automation requirements based on one or more such estimation rules; •adjusting one or more estimation rules based on real data associated with operation of a previous/current irrigation system; •estimating one or more of acquisition, installation and operating costs based on one or more of: hardware costs; radio network propagation characteristics (optionally of terrain, crop, etc); other factors that have historically contributed to ownership cost; •displaying to a user one or more of such estimated costs; •calculating one or more alternative designs and displaying the associated information.

### TECHNICAL FIELD

The present invention relates to a irrigation system and more particularly relates to designing and managing the designed irrigation system with optimum efficiency.

### BACKGROUND

The object of an irrigation system is to efficiently and effectively deliver the required amount of water, nutrient, and other inputs to the plant to achieve the desired production objective. The production objective can be varied, and can vary over time but includes maximizing yield, achieving optimal health and vigor of the plant, or delivering an acceptable outcome based on other constraints such as availability of inputs or other resources.

These optimizations of operation benefit greatly from monitoring the irrigation system whilst operating.

The physical water delivery system is usually designed first.

The physical water delivery system is usually designed to consider constraints such as cost of parts, availability and cost of water delivery, flow rates and other hydraulic and mechanical constraints and objectives.

The design does not consider the cost to own and operate.

The irrigation system design is not used post system installation. Information that is part of the design must be duplicated in other operational systems and can be in conflict with original design intent.

The reference to any prior art in this specification is not, and should not be taken as, an acknowledgement or any form of suggestion that the prior art forms part of the common general knowledge.

### SUMMARY

According to one aspect of the invention, it is possible to extend an irrigation system design phase to include the consideration of the cost and objectives of operational monitoring and automation and the total lifetime cost of ownership and operating of an irrigation system based on the subject design.

According to another aspect of the invention, there is provided functionality to incorporate the consideration of elements specific to operation, measurement, monitoring and automation of the irrigation system and optionally using machine learning and artificial intelligence to suggest improvements to the design to lower the total operating cost and improve the operational performance of the system.

In some aspects of the invention, an irrigation design is available in machine readable format in a way that includes all the operational constraints and objectives of the irrigation system relating to resource usage, operating conditions, crop information, operating objectives etc.

In some aspects of the invention, there is provided a computer operated software system, that can be embedded in irrigation controllers or hosted on servers and deployed in cloud environments that can access the irrigation system design in real time to achieve many new capabilities that can only be achieved with such access to a design in machine readable format. Such capabilities and novel applications include:
a. Enhanced, configuration-free, automated reporting
b. Machine-learning and AI-enhanced risk prediction and prevention

In some aspects of the invention there is provided a system and method of using the irrigation system design in machine readable format to assess the operational state of a currently operating irrigation system deployed in accordance with the design and to determine key operating characteristics and assess the extent to which current operating conditions are within the design constraints and meeting the design objectives of the irrigation system design.

In some aspects of the invention, there is provided a system and method to use a machine readable irrigation system design to allow, automatically guide, and verify the development of a program of irrigation that will not violate any of the design constraints of objectives.

In another aspect of the invention, there is provided a system and method of using artificial intelligence and machine learning techniques to suggest, develop and improve irrigation programs that describe the desired operation of an irrigation system such that it will operate within the design constraints and objectives of the irrigation system design.

In another aspect of the invention, there is provided a system and method for alerting relevant stakeholders, in a variety of communications channels of key events during the operation of an irrigation program that uses the machine readable design, historical performance data, machine learning and artificial intelligence techniques to detect anomalous behaviour, and identify opportunities for direct manual and automatic intervention that will minimize and avoid problems and create more desirable outcomes when considering the irrigation system design and other objectives provided with the irrigation program.

In another aspect of the invention there is provided a system and method for the provision of an interactive query service, hosted in a variety of computational environments such as embedded controllers, computer servers and cloud based environments that can accept queries in a plurality of forms (written, spoken, visual etc) and apply that query to the machine readable irrigation system design, the current operating state of an irrigation system or program and allow a person and a system to collaborate and reason about the state of the system, the extent to which the system is considered to be operating with established design constraints and suggest, co-develop, extrapolate and implement actions and changes to the irrigation program that will improve outcomes or avoid undesirable outcomes.

A system and method for the development and delivery of reports that summarise the operation of an irrigation program by referring to, collecting and summarising a combination of the irrigation system design, recorded operating data and predicted future state of the system, the operating environment and available resources to summarise the cost, time, usage and other characteristics of the program and to suggest automatic or manual improvements and other impacts of changes to the system, inputs, operating characteristics to achieve desirable outcomes and improve key characteristics such as economic performance, crop yield improvements, reduction in waste and exposure to risk of pest or disease.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

The detailed description is described with reference to the accompanying figures.

FIG. 1 illustrates a schematic of exemplary irrigation system design process in accordance with the present disclosure.

FIG. 2 illustrates a schematic showing an irrigation plan design process.

FIG. 3 illustrates a schematic showing example irrigation operational monitoring service and interactions.

FIG. 4 depicts an exemplary chatbot interaction in accordance with the present disclosure

FIG. 5 is an example irrigation summary as illustrated in accordance with the present disclosure.

FIG. 6 is another exemplary chatbot interaction in accordance with the present disclosure.

FIG. 7 is an example weekly report as illustrated in accordance with the present disclosure.

FIGS. 8 to 10 as illustrated are example interactions with conversational irrigation monitoring and management service in accordance with the present disclosure.

FIG. 11 is yet another exemplary chatbot interaction in accordance with the present disclosure.

### DETAILED DESCRIPTION

It is convenient to describe the invention herein in relation to an exemplary embodiment. The invention is applicable to a wide range of implementations and it is to be appreciated that other constructions and arrangements are also considered as falling within the scope of the invention. Various modifications, alterations, variations and or additions to the construction and arrangements described herein are also considered as falling within the ambit and scope of the present invention.

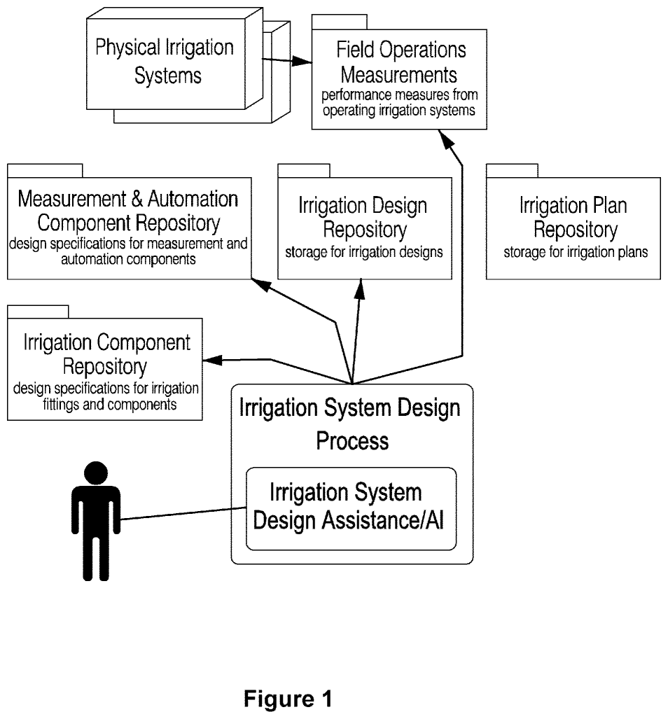

According to one aspect of the invention, it is possible to extend an irrigation system design phase to include the consideration of the cost and objectives of operational monitoring and automation and the total lifetime cost of ownership and operating of an irrigation system based on the subject design (FIG. 1).

Accordingly, one example implementation of the invention is a computer implemented method for designing an irrigation system comprising: receiving data associated with a proposed irrigation design; analysing a proposed design, comprising one or more of: proposed measurements and automation requirements; retrieving one or more pre-established estimation rules from a data store; estimating additional measurement and automation requirements based on one or more such estimation rules; adjusting one or more estimation rules based on real data associated with operation of a previous and/or current irrigation system.

The method further comprises estimating one or more of acquisition, installation and operating costs based on one or more of: hardware costs; radio network propagation characteristics (optionally of terrain, crop, etc); other factors that have historically contributed to ownership cost;
displaying to a user one or more of such estimated costs;
calculating one or more alternative designs which optionally offer the same or similar hydraulic properties and outcomes and superior ownership costs; such calculation optionally based on 10 one or more of: changing placement of key infrastructure; and combining or splitting system elements to improve one or more economic and/or performance outcomes; and
displaying information associated with at least one of the calculated alternative designs.

According to another aspect of the invention, there is provided functionality to incorporate the consideration of elements specific to operation, measurement, monitoring and automation of the irrigation system and optionally using machine learning and artificial intelligence to suggest improvements to the design to lower the total operating cost and improve the operational performance of the system (FIG. 1).

In some aspects of the invention, an irrigation design is available in machine readable format in a way that includes all the operational constraints and objectives of the irrigation system relating to resource usage, operating conditions, crop information, operating objectives etc (FIG. 1).

In some embodiments this may comprise one or more of:
a. Enhanced versions of existing software to extend file formats to include additional information 25
b. New XML or JSON formats which describe enhanced elements of irrigation system design
c. A cloud based repository for the exchange of meta-models that describe the ontology and allow for the specific modelling, storage and retrieval of files that encode and incorporate additional elements of irrigation system design. Current software can be enhanced to refer to these additional services by URI or other universal naming scheme locators.

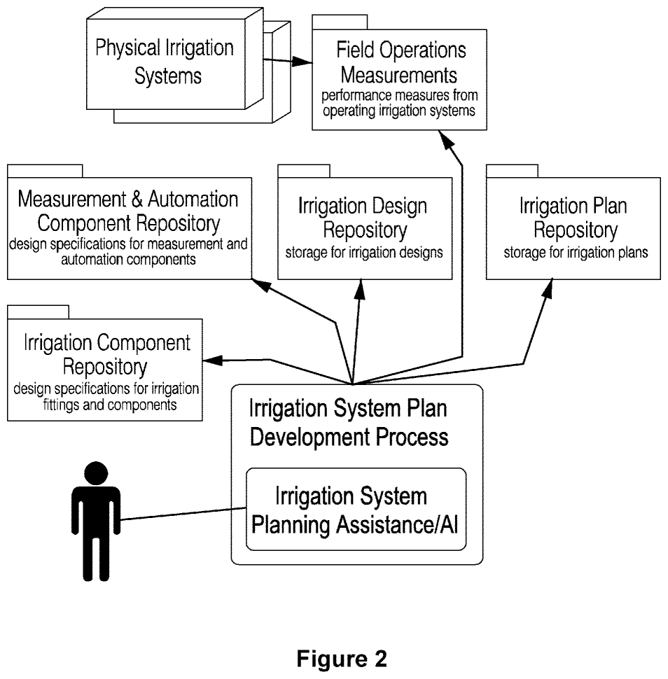

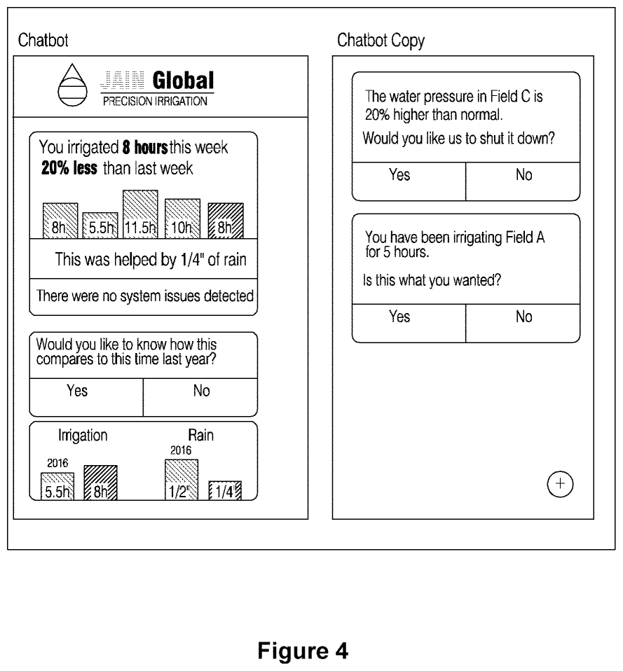

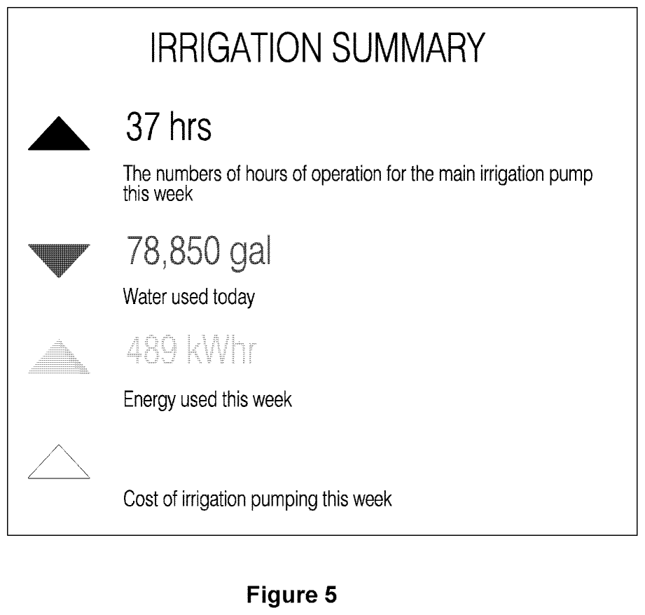

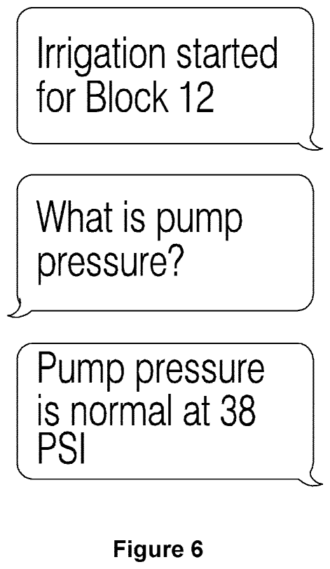

In some aspects of the invention, there is provided a computer operated software system, that can be embedded in irrigation controllers or hosted on servers and deployed in cloud environments that can access the irrigation system design in real time to achieve many new capabilities that can only be achieved with such access to a design in machine readable format—see FIGS. 2, 3 and 4.

The ability to provide operational alerting and reporting without any need for configuration beyond reading the original design, dramatically simplifying setup and reducing costs of installation and operation

Allowing for machine-learning and artificial intelligence systems to monitor currently operating systems and predict the presence of operating conditions that have occurred or may occur in the future, significantly reducing risk, preventing costly damage and reducing costs of ownership and operation

Accordingly, in some embodiments, there is provided a computer implemented method of irrigation system design comprising:
receiving an input associated with a user request to add and or edit an irrigation schedule;
optionally adjusting the input to fit a predetermined template (to allow for simpler comparison);
accessing in machine readable format an irrigation design relevant to the irrigation schedule;
comparing the input (or the optionally adjusted input) with the accessed irrigation design;
determining whether the input characteristics are incompatible with one or more parameters of the accessed irrigation design (for example exceed design capacity);
calculating one or more probable user requirements from the input data;
optionally identifying one or more alternative irrigation schedule modifications to meet one or more of the probable user requirements and also meet one or more (preferably all) constraints associated with the accessed irrigation design; and
alerting a user to an incompatibility if identified and optionally to one or more such alternatives.

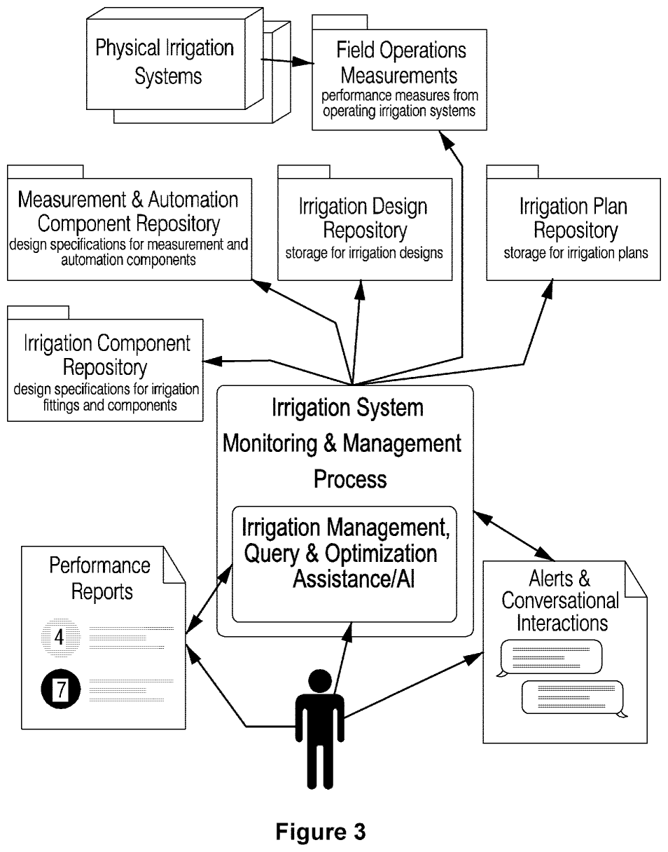

In some aspects of the invention there is provided a system and method of using the irrigation system design in machine readable format to assess the operational state of a currently operating irrigation system deployed in accordance with the design and to determine key operating characteristics and assess the extent to which current operating conditions are within the design constraints and meeting the design objectives of the irrigation system design (FIG. 3).

Accordingly in some embodiments of the invention there is provided a computer implemented method of managing an irrigation system comprising:
receiving a user input with instructions to commence an irrigation program at a specified time and preferably a specified date, the irrigation program preferably comprising a given volume and other relevant characteristics;
requesting irrigation data in relation to said irrigation program from one or more physical devices associated with the program, the devices may for example optionally be a water meter; a pump, etc accessing in machine readable format an irrigation design relevant to the irrigation schedule;
comparing the requested irrigation data with the accessed irrigation design;
determining from the requested irrigation data whether the input characteristics are compatible with one or more parameters of the accessed irrigation design (for example design capacity);
on detecting an incompatibility, determining one or more proposed remedial actions based on the irrigation design;
requesting from a user (visually, by sound or an other suitable means) instructions in relation to the one or more proposed remedial actions;
receiving an input from a user associated with the one or more proposed remedial actions;
comparing the input data with the accessed irrigation design to identify an efficient (preferably most efficient) method of performing a remedial action; and
communicating an instruction in relation to a remedial action to one or more physical devices associated with the irrigation program.

In some aspects of the invention, there is provided a system and method to use a machine readable irrigation system design to allow, automatically guide, and verify the development of a program of irrigation that will not violate any of the design constraints of objectives (FIG. 2).

Accordingly, in some embodiments, there is provided a computer implemented method comprising the steps:
presenting (optionally visually or verbally) to a user one or more possible irrigation elements based on a machine readable irrigation design, each element corresponding to a design feature which is configurable by user input, preferably such elements may be presented in a simple, easy to use format, such as building blocks to be put together in a range of ways to meet various irrigation design needs;
receiving input from a user in relation to one or more of said elements and a proposed irrigation program based on one or more of them;
in response to an input from a user, calculating an implied operational characteristic of the current proposed user design optionally by extracting key input from the machine readable irrigation design;
optionally simulating operation of an irrigation design for example by using the user supplied inputs in conjunction with one or more constraints associated with the irrigation design;
optionally alerting a user to an actual or possible incompatibility (for example violation of operating constraints) of the proposed design based on an output from the simulation.

In another aspect of the invention, there is provided a system and method of using artificial intelligence and machine learning techniques to suggest, develop and improve irrigation programs that describe the desired operation of an irrigation system such that it will operate within the design constraints and objectives of the irrigation system design (FIGS. 2 and 3).

Accordingly, according to some embodiments of the invention, there is provided a computer implemented method comprising:
combining one or more machine readable irrigation design elements and one or more irrigation-relevant parameters (such as crop type, soil type, local precipitation, weather conditions, etc), the parameters having been obtained from one or more sources comprising: an irrigation design, current and/or historical operating and/or environmental conditions, site specific data, data from similar sites, etc combining one or more machine learning model and/or simulations to determine a likely plant soil and/or water requirement;
comparing the water requirement with one or more model outputs and optionally one or more other sources (such as historical data from the same and similar sites);
selecting a preferred model optionally using a statistical method, the preferred model representing the current soil and/or plant water needs and being combined with the operating design constraints of the irrigation system design;
proposing (visually, by audio or any suitable means) to a user a proposed irrigation plan intended to provide the estimated soil and/or water and nutrient requirements whilst operating the irrigation system within design constraints for operating characteristics such as water pressure, water available, energy availability, energy cost, and other economic incentives and constraints;
optionally requesting input in relation to the proposed irrigation plan from a user;
optionally receiving an input from a user, which may for example comprise acceptance, amendments to the plan (with or without further computer-generated guidance relating to the likely impact of changes proposed by the user.

In another aspect of the invention, there is provided a system and method for alerting relevant stakeholders, in a variety of communications channels of key events during the operation of an irrigation program that uses the machine readable design, historical performance data, machine learning and artificial intelligence techniques to detect anomalous behaviour, and identify opportunities for direct manual and automatic intervention that will minimize and avoid problems and create more desirable outcomes when considering the irrigation system design and other objectives provided with the irrigation program (FIG. 3).

Accordingly, in some embodiments there is provided a computer implemented method comprising:
receiving or accessing data associated with operation of an irrigation system;
receiving or accessing data associated with an irrigation system plan associated with the said irrigation system;
comparing one or more parameters associated with operation of the system with the system plan and optionally also comparing with historical data associated with the system and other similar systems;
optionally using one or more statistical methods to predict the likelihood of certain operating characteristics exceeding design constraints or desirable limitations and conditions;
optionally comparing actual recorded operating conditions with the irrigation design and one or more other stated limitations;
optionally accessing and comparing information to determine an appropriate (preferably most appropriate) means of communication with stakeholders that have implicit or explicit stated interest in the operational state of the irrigation system;
optionally notifying via one or more selected methods one or more selected stakeholders with information about the operating state of the system, the potential or actual violation of certain operating constraints or the likelihood of such violation.

In another aspect of the invention there is provided a system and method for the provision of an interactive query service, hosted in a variety of computational environments such as embedded controllers, computer servers and cloud based environments that can accept queries in a plurality of forms (written, spoken, visual etc) and apply that query to the machine readable irrigation system design, the current operating state of an irrigation system or program and allow a person and a system to collaborate and reason about the state of the system, the extent to which the system is considered to be operating with established design 15 constraints and suggest, co-develop, extrapolate and implement actions and changes to the irrigation program that will improve outcomes or avoid undesirable outcomes (FIG. 3).

Accordingly, in some embodiments, there is provided a computer implemented method comprising:
receiving or accessing data in relation to operation of an irrigation system;
in response to said data, offering to a user one or more choices of remedial action and one or more methods for indicating a selection amongst such choices;
receiving an input associated with a user's choice in relation to the offered remedial actions;
sending an instruction associated with the user input, for example to alter or stop operation of a physical device or to set a time limit, or to send further information, etc.

In some embodiments, a user may request form a system according to the invention in relation to the likelihood of a defined outcome occurring. In response to such a request, a processor may operate a method according to the invention and use a statistical method and optionally combine data from one or more sources to simulate, extrapolate or otherwise estimate the likelihood of the defined outcome and thereafter respond to the user with a response, which 30 may for example be an estimate.

In some embodiments, a processor and user may exchange several communications to develop a preferred course of action. And a user may indicate the preferred course of action and request the system undertake said action.

A system and method for the development and delivery of reports that summarise the operation of an irrigation program by referring to, collecting and summarising a combination of the irrigation system design, recorded operating data and predicted future state of the system, the operating environment and available resources to summarise the cost, time, usage and other characteristics of the program and to suggest automatic or manual improvements and other impacts of changes to the system, inputs, operating characteristics to achieve desirable outcomes and improve key characteristics such as economic performance, crop yield improvements, reduction in waste and exposure to risk of pest or disease.

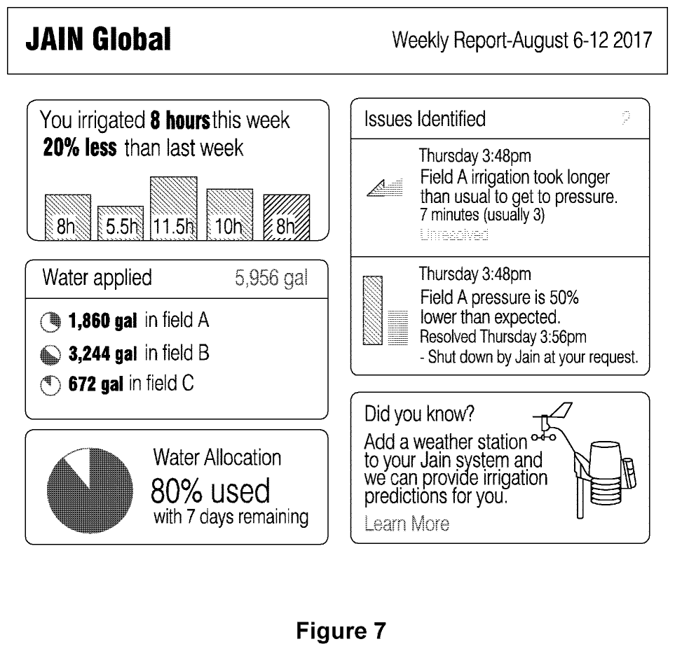

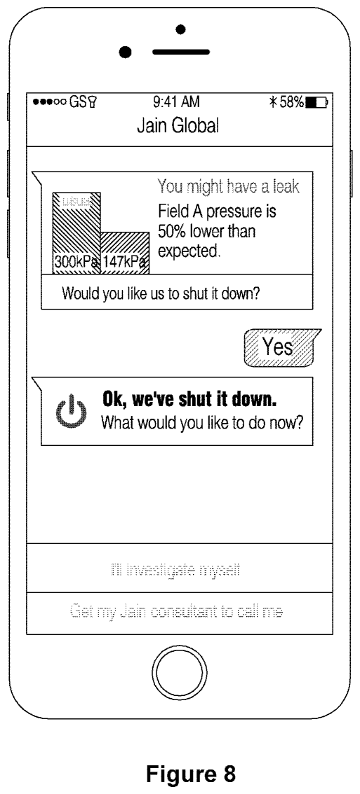

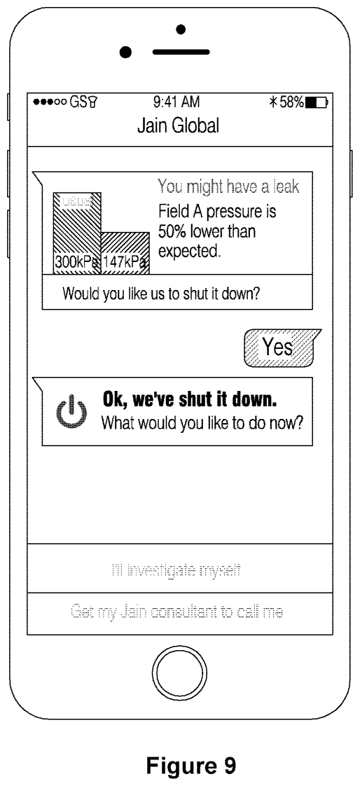

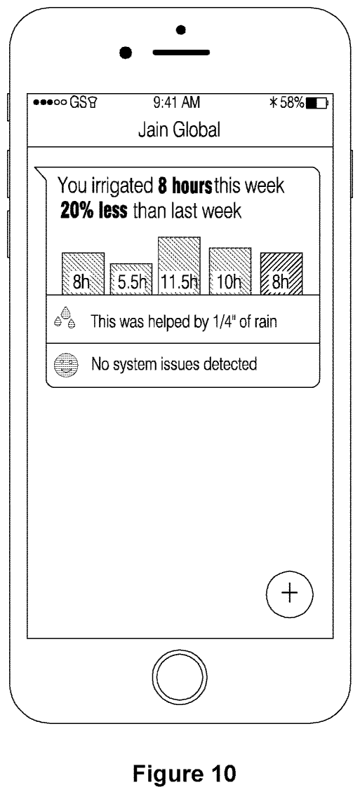

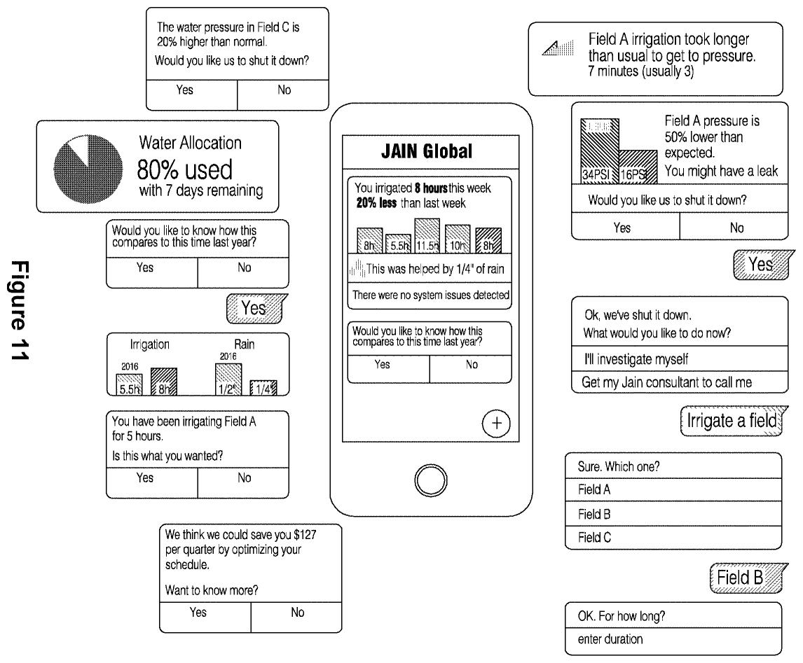

FIG. 7 is an example weekly report. Such a report may comprise any suitable data, for example some users may prefer per field data, or data highlighted for the largest fields, or those with the greatest variance, or highest probability of an incompatibility etc.

In some embodiments, data may be combined from various sources including but not limited to current and historical recording of irrigation system performance from this and other irrigation systems, machine-readable irrigation design and other configuration data, environmental data, crop models and other sources of agronomic knowledge to determine the desired irrigation program and compare it to the recorded performance of the actual irrigation program.

In some embodiments, the system may combine data, extrapolations, simulations and other statistical methods to provide comparison of the subject irrigation plan to other plans and other comparable activities to place the information in a context of operating performance, statistical variation and comparative performance to other comparable systems and methods.

In some embodiments, the system may create written and visually represented reports to convey the actual performance and comparative, quantitative and qualitative assessment in a visual and written form than will be delivered to the User in a variety of formats and via a variety of channels.

We claim:

1. A method for optimally designing an irrigation system and managing/operating the designed irrigation system in real time, the method comprising:
a. receiving data associated with a proposed irrigation design;
b. analysing the proposed design, wherein the proposed design further comprises one or more proposed measurements and automation requirements;
c. retrieving one or more pre-established estimation rules from a data store, and mapping the retrieved estimation rule with the proposed design;
d. estimating additional measurement and automation requirements based on one or more such estimation rules;
e. adjusting one or more estimation rules based on real data associated with operation of a previous and/or a current irrigation system;
f. estimating one or more of acquisition, installation and operating costs based on one or more of: hardware costs; radio network propagation characteristics (optionally of terrain, crop, etc); other factors that have historically contributed to ownership cost;
g. displaying to a user one or more of such estimated costs;
h. calculating one or more alternative designs which optionally offer the same or similar hydraulic properties and outcomes and superior ownership costs; such calculation optionally based on one or more of: changing placement of key infrastructure; and combining or splitting system elements to improve one or more economic and/or performance outcomes; and
i. displaying information associated with at least one of the calculated alternative designs.

2. A method for optimally designing an irrigation system and managing/operating the designed irrigation system in real time, the method comprising:
receiving an input as a user request to edit an irrigation schedule;
comparing the input with a template, wherein the template corresponds to the designed irrigation system and is updated real time;
determining whether the input characteristics are incompatible with one or more parameters of the template;
calculating one or more probable user requirements from the input data;
optionally identifying one or more alternative irrigation schedule modifications to meet one or more of the probable user requirements and also meet one or more constraints associated with the template; and
alerting a user to an incompatibility if identified and optionally to one or more such alternatives.

3. The method as claimed in claim 2, further comprises optionally adjusting the input to fit a predetermined template, wherein the template is selected for the specific designed irrigation system.

4. A method for optimally designing an irrigation system and managing/operating the designed irrigation system in real time, the method comprising:
receiving a user input with instructions to commence an irrigation program at a specified time;
requesting irrigation data in relation to said irrigation program from one or more physical devices associated with the irrigation program, wherein at least one device is selected from a water meter, a pump; and
communicating the instruction to one or more physical devices associated with the irrigation program.

5. The method as claimed in claim 4, further comprises accessing a template with an irrigation design relevant to the irrigation schedule.

6. The method as claimed in claim 4, further comprises comparing the requested irrigation data with the accessed template.

7. The method as claimed in claim 4, further comprises determining from the requested irrigation data whether the input characteristics are compatible with one or more parameters of the accessed irrigation design.

8. The method as claimed in claim 7, further comprises on detecting an incompatibility, determining one or more proposed remedial actions based on the irrigation design.

9. The method as claimed in claim 8, wherein determining one or more proposed remedial actions further comprises:
requesting from a user instructions in relation to the one or more proposed remedial actions;
receiving an input from a user associated with the one or more proposed remedial actions; and
comparing the input data with the accessed irrigation design to identify an efficient method of performing a remedial action.

10. The method as claimed in claim 8, wherein determining one or more proposed remedial actions further comprises:
offering to a user one or more choices of remedial action and one or more methods for indicating a selection amongst such choices;
receiving an input associated with a user's choice in relation to the offered remedial actions;
sending an instruction associated with the user input.

11. A method for optimally designing an irrigation system and managing/operating the designed irrigation system in real time, the method comprising:
receiving or accessing data associated with operation of an irrigation system;
receiving or accessing data associated with an irrigation system plan associated with the said irrigation system;
comparing one or more parameters associated with operation of the system with the system plan and optionally also comparing with historical data associated with the system and other similar systems;
optionally using one or more statistical methods to predict the likelihood of certain operating characteristics exceeding design constraints or desirable limitations and conditions;
optionally comparing actual recorded operating conditions with the irrigation design and one or more other stated limitations;
optionally accessing and comparing information to determine an appropriate means of communication with stakeholders that have implicit or explicit stated interest in the operational state of the irrigation system;
optionally notifying via one or more selected methods one or more selected stakeholders with information about the operating state of the system, the potential or actual violation of certain operating constraints or the likelihood of such violation.
